(19) United States
(12) Patent Application Publication
(10) Pub. No.: US 2010/0023520 A1
(43) Pub. Date: Jan. 28, 2010

(54) ENCAPSULATED FILE MANAGEMENT SYSTEMS

(75) Inventors: Dmitry Barboy, Rishon Le Zion (IL); Anatoly Kardash, Rishon Le Zion (IL); Roman Listiev, Rehovot (IL); Mikhail Iavnilovitch, Rehovot (IL); Leonid Shtilman, Lexington, MA (US)

Correspondence Address: OCCHIUTI ROHLICEK & TSAO, LLP, 10 FAWCETT STREET, CAMBRIDGE, MA, 02138, US

(73) Assignee: Viewfinity Inc., Waltham, MA (US)

(21) Appl. No.: 12/180,749

(22) Filed: Jul. 28, 2008

(51) Int. Cl. G06F 17/30; G06F 12/00

(52) U.S. Cl. 707/8; 707/203; 707/10; 711/154; 707/E17.007; 711/E12.001

(57) ABSTRACT

Methods, systems, and apparatus, including computer program products, for processing element access requests in a computing environment having a plurality of applications, by managing versions of elements of a first set of applications as belonging to respective application execution groups of a first group type, each application execution group of the first group type having a unique group identifier; identifying a source of a first element access request as being associated with the first set of applications, the first element access request including a first element identifier; based on the identified source of the first element access request, selecting a version of an element stored in association with the first element identifier from amongst the managed versions of the elements of the first set of applications; and processing the first element access request using data representative of the selected version of the element.

### BACKGROUND

This description relates to encapsulated file management systems.

Modern computer operating systems include complex file system schemas. For example, the various incarnations of Microsoft Windows use a file folder approach including special folder names contextually associated with various other folders, for example through the use of environment variables. Some operating systems also use configuration databases, for example most variants of Microsoft Windows use a registry for additional data, including configuration specifics. Applications make varying use of the available file system schema and, when multiple applications are installed in a single computing environment, the file system usage between applications can overlap, leading to conflicts and unexpected overwrites.

In a simple installation of an application, a single executable file is placed in the file system and no additional provisioning is required. In a more complex installation, additional files may need to be placed in the file system and other configuration and provisioning steps may be required. For example, some executable files, when executed, load additional files into operational memory (e.g., dynamic link libraries, “DLL”s). Some of these libraries may be included with the operating system and commonly shared across installations. Other libraries may be custom libraries written for the application and included along side the executable file. An executable that uses a large amount of static data, for example a language dictionary or a collection of graphics, may use additional data files separate from the executable file. Some executables may invoke additional executables, for example to handle background tasks or provide nested support. An installation process may also create new files. For example, a process might create files containing customization information or a file directory address for the proper executable along with any operation flags and configuration metadata. One example of this is the Microsoft Windows Shortcut. The installation may cause the shortcut file to be placed in a shared location, for example a directory of shortcuts for display to the user on a menu. There are many additional types of files that may also be included in an installation.

Complex application installations can include a large number of files, which may be written to a variety of locations. Some of the locations may be shared with other installations, presenting the problem that a file might be overwritten by another installation. In addition to file placement, installation may also modify operating system tables and databases, for example by placing information in the Microsoft Windows Registry. In some applications the installation and provisioning process is scripted, for example using the Microsoft Windows Installer (“MSI”), which relies on installation packages to know where to place files and update the registry. The MSI installation data also includes information for uninstalling the package; this information is also stored by the operating system. The Windows Installer presents an imperfect approach. Not every application uses the system. Once an application is installed it can be de-synchronized from the uninstall information if, for example, a user moves files manually.

File schemas are further complicated by computer users. People use computer applications to generate new files. These files can be created in numerous ways and contain a variety of data. Word processors are used to generate documents, image editors and cameras are used to generate digital photos and movies, compilers are used to generate new programs, computer games generate high score files and saved game information, and web browsers generate cookies. Some files are generated as an updated version of an existing file, which may originally have been generated by a different application. Almost every computer application generates additional files through use. Where these files go is generally a function of the file system schema.

### SUMMARY

In general, in one aspect, the invention features a method for processing element access requests in a computing environment having a plurality of applications, the method includes managing versions of elements of a first set of applications as belonging to respective application execution groups of a first group type, each application execution group of the first group type having a unique group identifier; identifying a source of a first element access request as being associated with the first set of applications, the first element access request including a first element identifier; selecting, based on the identified source of the first element access request, a version of an element stored in association with the first element identifier from amongst the managed versions of the elements of the first set of applications; and processing the first element access request using data representative of the selected version of the element.

Aspects of the invention may include one or more of the following features.

The elements of the first set of applications may include one or more of executable files, dynamic link libraries, configuration files, registry entries, and user generated files. The first set of applications may include a subset of the plurality of applications of the computing environment. The first set of applications may include a proper subset of the plurality of applications of the computing environment. The selected version of the element may further be stored in association with a group identifier. The first group type may be a non-isolated group type and the selected version of the element may be further stored in association with a group identifier of an application execution group of the first group type. The version of the element selected based on the identified source of the first element access request may be a most recent version of the element with respect to the application execution groups of the first group type.

The method may further include managing versions of elements of a second set of applications as belonging to respective application execution groups of a second group type; identifying a source of a second element access request as being associated with the second set of applications, the second element access request including the first element identifier; selecting, based on the identified source of the second element access request, a version of an element stored in association with the first element identifier from amongst the managed versions of the elements of the second set of applications; and processing the second element access request using data representative of the version of the element selected based on the identified source of the second element access request.

The version of the element selected based on the identified source of the first element access request may be different from the version of the element selected based on the identified source of the second element access request. The version of the element selected based on the identified source of the second element access request may be a most recent version of the element with respect to the application execution groups of the second group type. The second group type may comprise an isolated group type, and the version of the element selected based on the identified source of the second element access request may further be stored in association with a group identifier of an application execution group of the second group type.

The first element access request may be for access to a file. The first element access request may be for access to an entry in a registry.

In general, in another aspect, the invention features a method for processing read/write requests in a computing environment having a plurality of applications, the method including managing versions of elements of a first set of applications as belonging to respective application execution groups of a first group type, each application execution group of the first group type having a unique group identifier; receiving a write request that includes a first element identifier and an element content; identifying a source of the write request as being associated with a first application execution group of the first group type; and executing a write operation that includes storing the element content in association with both the first element identifier and a group identifier of the first application execution group.

Aspects of the invention may include one or more of the following features.

The elements of the first set of applications may be executable files, dynamic link libraries, configuration files, registry entries, and/or user generated files. The first group type may be an isolated group type. The first group type may be a non-isolated group type.

The method may include receiving a read request that includes the first element identifier; identifying a source of the read request as being associated with the first application execution group of the isolated group type; identifying a most recent version of an element stored in association with both the first element identifier and the group identifier of the first application execution group; and processing the read request using data representative of the identified most recent version of the element.

The method may include receiving a read request that includes the first element identifier; identifying a source of the read request as being associated with a second application execution group of the isolated group type; identifying a most recent version of an element that is either: (a) stored in association with the first element identifier and a group identifier of an application execution group of a non-isolated group type, or (b) stored in association with the first element identifier and not stored in association with a group identifier; and processing the read request using data representative of the identified most recent version of the element.

The method may include receiving a read request that includes the first element identifier; identifying a source of the read request as being associated with a second application execution group of the non-isolated group type; identifying a most recent version of an element that is either: (a) stored in association with the first element identifier and a group identifier of an application execution group of a non-isolated group type, or (b) stored in association with the first element identifier and not stored in association with a group identifier; and processing the read request using data representative of the identified most recent version of the element.

The element content may include registry content. The element content may include file system content.

In general, in another aspect, the invention features a method including managing versions of elements of a first set of applications of a computing environment as belonging to respective application execution groups; maintaining a first group-specific temporal snapshot sequence for a first application execution group, each snapshot of the first group-specific temporal snapshot sequence including data representative of a state of each element of the first application execution group at a point in time corresponding to a detection of a snapshot trigger event, wherein the state of each element is based in part on the effects of one or more write operations initiated by respective sources associated with the first application execution group between snapshot trigger events corresponding to adjacent points in time; and processing the first group-specific temporal snapshot sequence to restore one or more of the elements of the first application execution group to its respective state at a point in time corresponding to a specific snapshot trigger event.

Aspects of the invention may include one or more of the following features.

The method may include maintaining a second group-specific temporal snapshot sequence for a second application execution group, each snapshot of the second group-specific temporal snapshot sequence including data representative of a state of each element of the second application execution group at a point in time corresponding to a detection of a snapshot trigger event, wherein the state of each element is based in part on the effects of one or more write operations initiated by respective sources associated with the second application execution group between snapshot trigger events corresponding to adjacent points in time; and processing the second group-specific temporal snapshot sequence to restore one or more of the elements of the second application execution group to its respective state at a point in time corresponding to the specific snapshot trigger event.

The elements of the first set of applications may include one or more of executable files, dynamic link libraries, configuration files, registry entries, and user generated files. The first set of applications may be a subset of the plurality of applications of the computing environment. The first set of applications may be a proper subset of the plurality of applications of the computing environment.

In general, in another aspect, the invention features

A method including managing versions of elements of a first set of applications of a computing environment as belonging to respective capsules; maintaining one or more capsule-specific temporal snapshot sequences for each application of the first set, each capsule-specific temporal snapshot sequence comprising information sufficient to enable elements of an application to reflect its respective state at a point in time corresponding to a specific snapshot trigger event; and processing a capsule-specific temporal sequence for a first application of the first set and a capsule-specific temporal sequence for a second application of the first set to concurrently enable elements of the first application to reflect its respective state at a first point in time and elements of the second application to reflect its respective state at a second point in time.

Aspects of the invention may include one or more of the following features:

The second point in time may be subsequent to the first point in time.

The method may include concurrently enabling elements of the first application to reflect its respective state at a point in time corresponding to a first snapshot trigger event and elements of the second application to reflect its respect state at the point in time corresponding to the first snapshot trigger event.

Maintaining one or more capsule-specific temporal snapshot sequences for each application of the first set may include maintaining a first capsule-specific temporal snapshot sequence for a first version of the first application and maintaining a second capsule-specific temporal snapshot sequence for a second version of the first application. The elements of the first set of applications may include executable files, dynamic link libraries, configuration files, registry entries, and/or user generated files. The first set of applications may include a subset of the plurality of applications of the computing environment. The first set of applications may include a proper subset of the plurality of applications of the computing environment.

In general, in one aspect, the invention features a distributed system hosted on a plurality of interconnected nodes of a data network, the system including a first node of the data network, the first node including a processor and a machine-readable medium that stores instructions executable by the processor to manage versions of elements of a first set of applications hosted on the first node as belonging to respective application execution groups of a first group type, each application execution group of the first group type having a unique group identifier; identify a source of a first element access request as being associated with the first set of applications, the first element access request including a first element identifier; select, based on the identified source of the first element access request, a version of an element stored in association with the first element identifier from amongst the managed versions of the elements of the first set of applications; and process the first element access request using data representative of the selected version of the element.

Aspects of the invention may include one or more of the following features.

The elements of the first set of applications may be executable files, dynamic link libraries, configuration files, registry entries, and/or user generated files. The selected version of the element may be stored in association with a group identifier. The first group type may be a non-isolated group type and the selected version of the element may be stored in association with a group identifier of an application execution group of the first group type. The version of the element selected based on the identified source of the first element access request may be a most recent version of the element with respect to the application execution groups of the first group type.

The machine-readable medium of the first node may also store instructions executable by the processor to: manage versions of elements of a second set of applications as belonging to respective application execution groups of a second group type; identify a source of a second element access request as being associated with the second set of applications, the second element access request including the first element identifier; based on the identified source of the second element access request, select a version of an element stored in association with the first element identifier from amongst the managed versions of the elements of the second set of applications; and process the second element access request using data representative of the version of the element selected based on the identified source of the second element access request.

The version of the element selected based on the identified source of the first element access request may be different from the version of the element selected based on the identified source of the second element access request. The version of the element selected based on the identified source of the second element access request may be a most recent version of the element with respect to the application execution groups of the second group type. The second group type may be an isolated group type, and the version of the element selected based on the identified source of the second element access request may be stored in association with a group identifier of an application execution group of the second group type.

The machine-readable medium of the first node may also store instructions executable by the processor to: receive elements of a first application from a second node of the data network; and manage the received elements of the first application as belonging to a first application execution group of the first group type.

The system may also include a second node of the data network, the second node including a processor and a machine readable medium that stores elements of a second set of applications and instructions executable by the processor to process a request for elements of an application of the second set and send elements of the application of the second set to a source of the request.

The source of the request may be the first node of the data network. The source of the request may be a third node of the data network. The first node of the data network may be a client computing system and the second node of the data network may be a server computing system.

In general, in one aspect, the invention features a distributed system hosted on a plurality of interconnected nodes of a data network, the distributed system including a first node of the data network, the first node including a processor; a first machine-readable medium that stores a set of data collections, each data collection being comprised of one or more elements of a particular content type; and a second machine readable medium that stores instructions executable by the processor to receive a request specifying a first data collection of the set and send one or more elements of the first data collection of the set to a source of the request.

Aspects of the invention may include one or more of the following features.

The system may also include a second node of the data network, the second node including: a processor; and a machine-readable medium that stores instructions executable by the processor to receive one or more elements of a first content type from the first node and manage the received one or more elements as belonging to a first data collection of the first content type.

The first node of the data network comprises a server computing system and the second node of the data network comprises a client computing system. The machine-readable medium of the second node may also store instructions executable by the processor to generate a request of one or more other elements of the first content type and send the generated request to the first node. The machine-readable medium of the second node may also store instructions executable by the processor to receive the one or more other elements of the first content type from the first node and manage the received one or more elements and the received one or more other elements as belonging to the first data collection of the first content type. The machine-readable medium of the second node may also store instructions executable by the processor to generate a request of one or more other elements of the first content type and send the generated request to a third node.

The machine-readable medium of the second node may also store instructions executable by the processor to receive the one or more other elements of the first content type from the third node and manage the one or more elements received from the first node and the one or more other elements received from the second node as belonging to the first data collection of the first content type.

The data collections of the set may include one or more of the following: an operating system data collection, an application program data collection, a user data collection, and a configuration data collection. The source of the request may be the second node of the data network. The source of the request may be a third node of the data network.

Other general aspects include other combinations of the aspects and features described above and other aspects and features expressed as methods, apparatus, systems, computer program products, and in other ways.

Other features and advantages of the invention are apparent from the following description, and from the claims.

### DESCRIPTION OF DRAWINGS

FIG. 1 is a block diagram.

FIG. 2 is a line diagram of a file system hierarchy tree.

FIG. 3 is a block diagram.

FIG. 4 is a set of line diagrams of a file system hierarchy tree.

FIG. 5 is a flow chart.

FIG. 6 is a block diagram.

### DESCRIPTION

One approach to managing a file system is to maintain an association between the various elements of an application, where elements include executable files, DLLs, configuration files, registry entries, user generated files, and any other file or system state used by the application. The aggregation of application elements, managed as a whole, is referred to in this description as a “capsule”. The process of aggregating the application elements is referred to in this description as “application encapsulation”, or simply “encapsulation”, with the resulting state referred to as an “encapsulated application.” In some cases multiple applications are managed as a single capsule.

A capsule manager may be implemented to create capsules, manage the association between an application and its capsule, manage the interaction between applications, and to provide additional features enabled by the use of encapsulation. The actions performed by a capsule manager are generally transparent to applications. That is, each application, including a user shell or graphical file system explorer, is presented with a view of the file system and, if present, registry, that is consistent with the ordinary view present without a capsule manager. An application does not need to be modified or developed in a manner to accommodate the use of a capsule manager.

Encapsulating an application includes associating files and settings related to the application into associative capsules. An encapsulated file management system encapsulates and separates applications from the underlying operating system. Each application, or application group, is managed separately from the interaction between the operating system and other applications. Each capsule includes the application executable and its associated files. Some capsules include multiple application executables, as appropriate for the application or application group. At the same time, the system allows and enables file sharing between different encapsulated (and/or non-encapsulated) applications. A file from a first capsule (or not in a capsule at all) that is modified by an application within a second capsule is encapsulated, in modified form, within the second capsule. This leaves the original version, found in the first capsule, unmodified within the first capsule. File versions are tracked by a capsule manager so that, in some examples, subsequent use of a file is always from the most recent version, regardless of capsule.

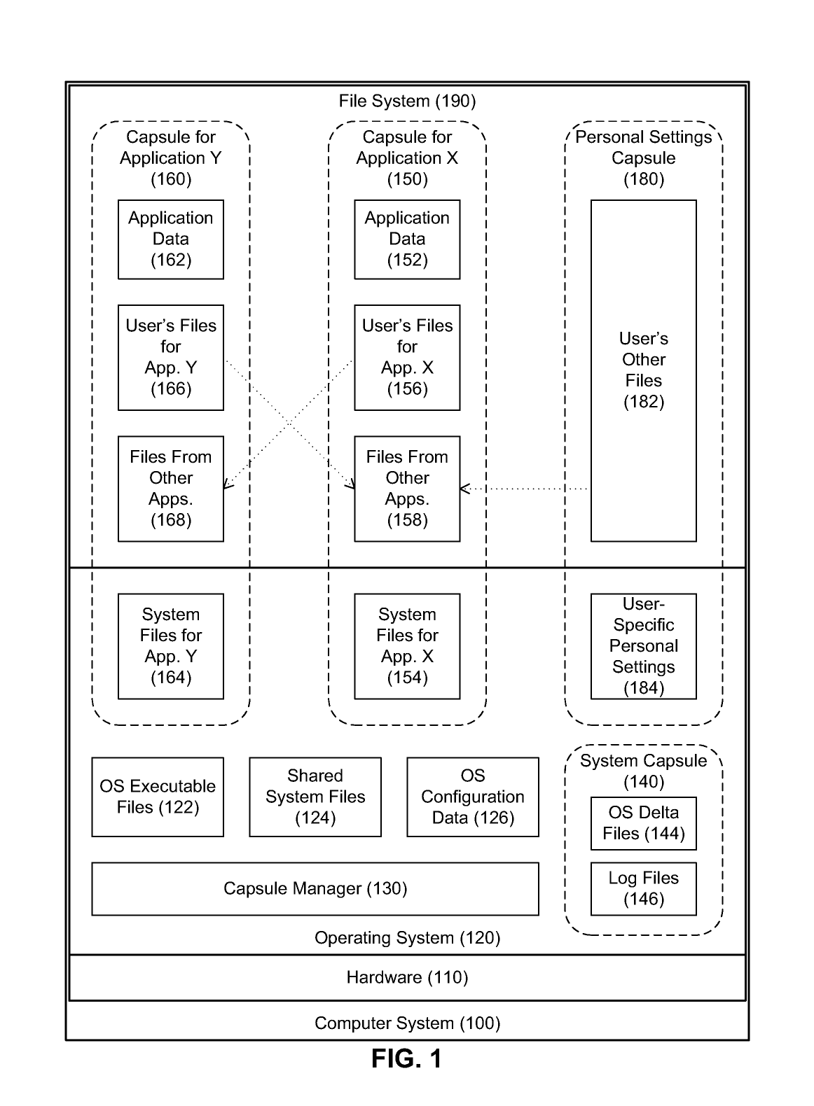

Referring to FIG. 1, in an example computer system 100, hardware 110 and an operating system 120 executing on the hardware manages the interactions between users, software, and hardware. A file system 190 is hosted on the hardware and provides an arrangement of data on the hardware for storing installed application files and user files. A typical operating system includes system applications 122, e.g., management utilities, administrative tools, and simple text and image editors; shared system files 124, e.g., hardware drivers; and operating system configuration data 126, e.g., settings stored in a registry.

Example computer system 100 also includes a Capsule Manager 130 that creates and manages capsules. The capsule manager 130 manages a system capsule 140, an application capsule for each application or set of applications (e.g. a capsule for Application X 150 and a capsule for Application Y 160), and a personal settings capsule for each user (e.g., personal settings capsule 180). The system capsule 140 encapsulates alterations to the original operating system installation, for example in the form of delta files 144, and operating system log files 146. The system capsule 140 may also encompass some types of system applications, while others may be treated as stand alone applications placed in capsules. For example, Microsoft® Corporation generally bundles a text editor (notepad.exe) with their operating systems. In some embodiments, separate capsules are used to manage the activities of some bundled applications, for example, a notepad capsule for the Microsoft® bundled text editor. The personal settings capsule 180 manages user files 182, e.g., user files not associated with an encapsulated application such as files copied into the system by the user, and user-specific operating system settings 184, e.g., printer configurations and display settings.

In some examples, a new application is handled within a capsule created by the Capsule Manager 130 for that application. When an application, e.g., “Application X”, is installed on the example computer system 100 a capsule 150 is created by the capsule manager 130 to handle the application. The application data 152 for “Application X”, e.g., the executable file for the application, and the application's system files 154, e.g., a DLL for the application, are stored within the application's capsule 150. In some embodiments, all files created by an application installation process are included in the application's capsule. As Application X is used by a user, user files 156 are generated and stored within the capsule 150. Likewise, capsule manager 130 creates another capsule 160 for installation and use of a second application, for example “Application Y”.

In some cases, the user can also use one application, e.g., Application X, to work with application files from another application, e.g., Application Y. In this case any files 166 read by Application X remain in the Application Y capsule. Any files modified 158 by Application X are saved within the Application X Capsule 150. The original versions of these files are left unmodified, for example as Application Y user files 166. Because a file is only duplicated when there is a modification, this is known as copy-on-write. Modifications in a copy-on-write strategy are either handled by first copying the file and then altering the copy, or where more efficient, writing a new version of the file with the modifications without needing to copy the file. Registry access is managed in the same manner as file access, with registry keys duplicated as needed.

In some embodiments, capsule manager 130 intercepts each registry or file system request from each requesting process and replaces registry key and file paths in the request with registry keys and file paths from the encapsulated file system schema appropriate for the requesting application. The capsule manager 130 determines the correct capsule view for the requesting process and, as a function of the requested file or registry key, the requesting process, and the proper system view, determines the native file path or registry key for use in the substitution. The replacement request is passed to the operating system 120 or storage hardware 110. The request response can then be sent to the originating process. In some implementations, requests are intercepted using a kernel level driver. In some implementations, the request-response passes through the capsule manager 130. In some implementations, the capsule manager 130 interacts directly with the hardware 110, without using the operating system 120.

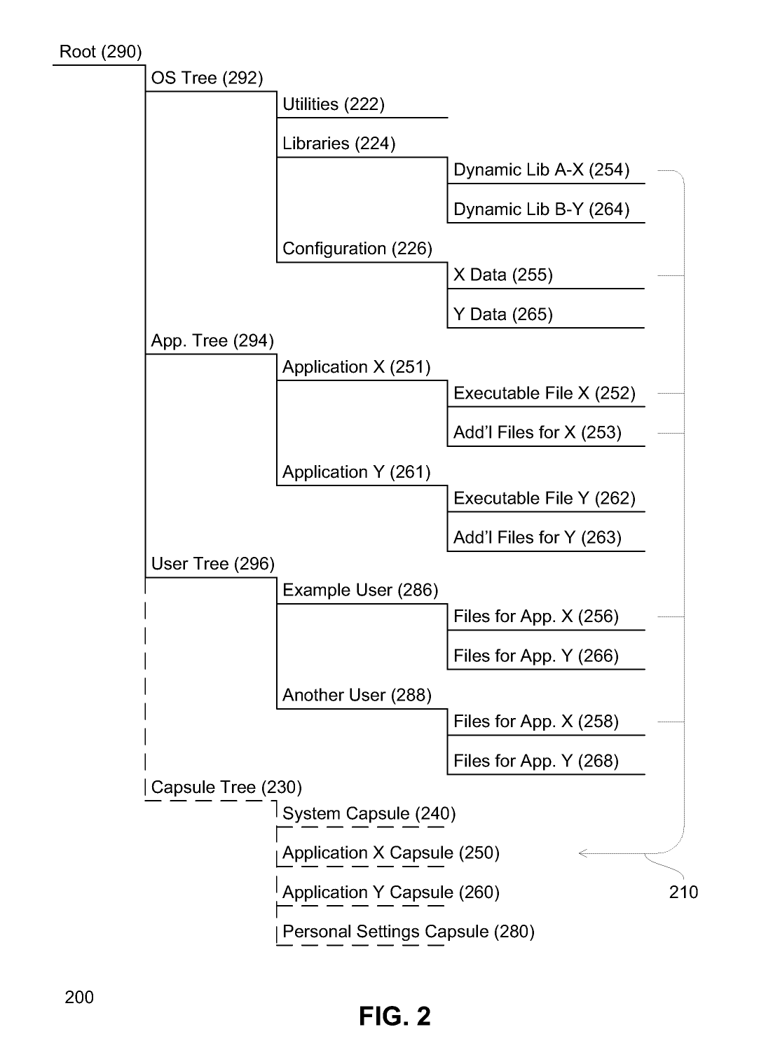

Referring to FIG. 2, a typical operating system file system schema on a single volume 200 starts with a root 290, for example “C:\”. There are a number of directories in the root grouping together related sub-directories. A typical configuration includes an operating system tree 292, for example “C:\WINDOWS\” and one or more application trees 294, for example “C:\Program Files\”. Most operating systems include additional software, for example configuration utilities, system monitors, and other rudimentary applications. This software is typically collected into a “bin” directory or spread into several directories, for example split between the OS Tree 292 and the Application Tree 294. In the present example, they are collected together in the OS Tree 292 in Utilities directory 222. Also in the OS Tree 292 is a directory for additional libraries 224, e.g., DLLs, and a directory for configuration data 226. Some systems also include a user file tree 296, for example “C:\Documents and Settings\”. Systems supporting multiple users typically include directories in the user file tree for each user, for example a user 286 and another user 288.

When an application is installed in a system without a capsule manager 130 the installation process typically creates a directory in the application tree 294 and adds files to folders in the OS tree 292, for example adding additional DLLs to the libraries directory 224. In some cases an installation also adds files or a special sub-directory to each user's file tree. For example, installation of Application X expands the application tree 294 by adding an Application X directory 251 containing an executable file 252 and additional application files 253. Installation of Application X also adds a DLL 254 in the libraries directory 224, configuration data 255 in the configuration directory 226, and user files in each user directory (shown as files 256 under primary example user 286 and files 258 under another user 288).

Each subsequent installation of an application further grows the directory structure and adds files to directories in the OS Tree 292. For example, installation of Application Y expands the application tree 294 by adding an Application Y directory 261 containing an executable file 262 and additional application files 263. Installation of Application Y also adds a DLL 264 in the libraries directory 224, configuration data 265 in the configuration directory 226, and user files in each user directory (shown as files 266 under primary example user 286 and files 268 under another user 288).

When an application is installed in a system with a capsule manager 130, the native directory structure remains as a view of the file system for processes invoked by the user. However, the capsule manager intercepts each file system request and replaces paths and file locations in the request with paths and files locations from the encapsulated file system schema appropriate for the requesting application, as described above. The rerouting is managed by capsule manager 130, which presents a capsule-specific file system view to each application (including, for example, a user shell). As explained below, there are two types of capsules, for purposes of determining a view, isolated and general capsules. An application in an isolated capsule only has a view of files stored within the capsule and the most recent versions of files not within the isolated capsule. An application in a general capsule has a unified view of the most recent version of every file not within an isolated capsule. An application not managed in a capsule is presented the same unified view as if the application were in a general capsule. The view is translated to the capsule schema, locating files in the underlying native file system, by the capsule manager.

In some implementations, the capsule manager 130 creates a capsule tree 230 to serve as a root for the capsule schema. Modifications made to the operating system and/or made using the software in Utilities directory 222 are captured in system capsule 240. All files created or related to an application are located in the capsule associated with the application. For example, installation of Application X creates Application X Capsule 250. Access to a file stored in Application Tree\Application X 251 is rerouted 210 to access a file in Application X Capsule 250. Additionally, operating system configurations, on a user level, are stored in personal settings capsule 280. Where configuration data is stored in a registry not accessible via the file system, registry access is managed in the same manner using a special capsule tree of registry entries.

Other embodiments and implementations store capsule contents and data in other formats. For example, instead of using special directories, data is located in databases. In another example, special archive files are used. In some implementations, the capsule manager uses a journaling approach to file management. In a journaling approach, the capsule manager uses the native directory schema in combination with capsule journals. References for files in a capsule are recorded in a journal maintained for the capsule. Where a filename in one capsule conflicts with a filename in another capsule, the capsule manager supplies a pseudonym for one or both files. For example, a file “sample.dat” modified by Application X might be named “sample.dat.Capsule_X”. A subsequent modification by Application Y might be named “sample.dat.Capsule_Y”. In some examples, versioning information is also incorporated into the filename. Where configuration data is stored in a registry not accessible via the file system, registry access is managed in the same manner using capsule named registry entries.

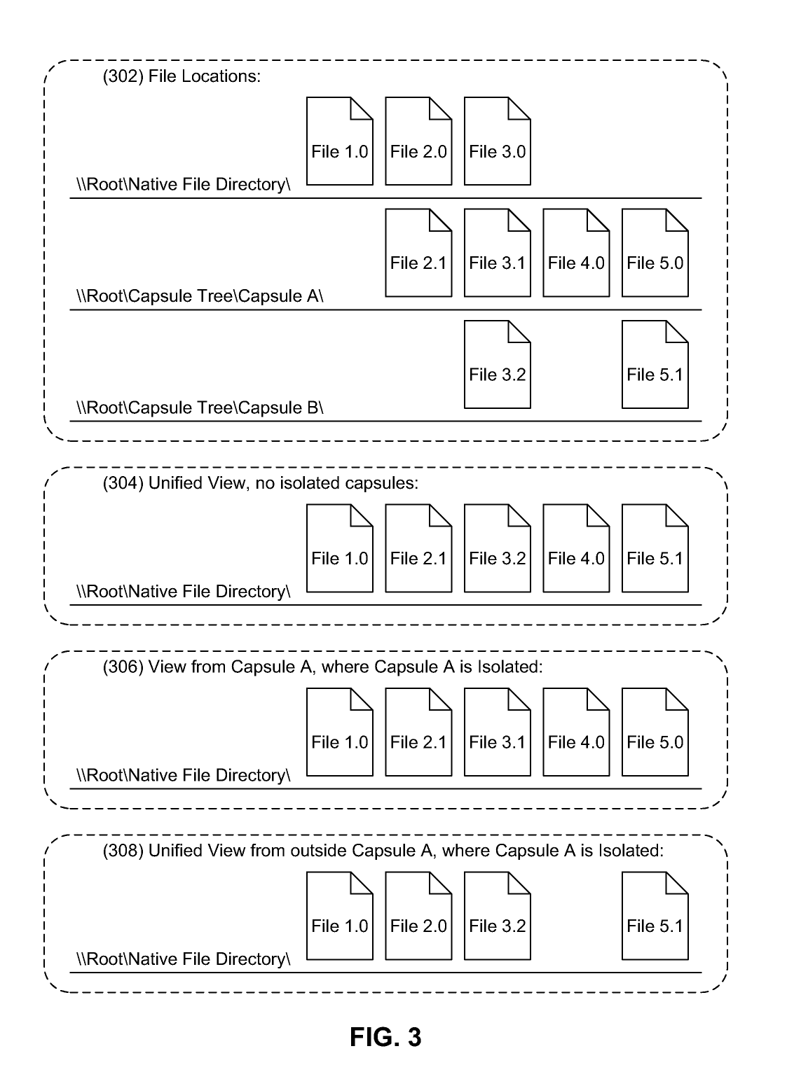

Referring to FIG. 3, in some implementations, different versions of the same file are stored in different locations. Five example files are sufficient to demonstrate file view perspectives, using three file locations 302: In an un-encapsulated directory there are original file versions for File 1.0, File 2.0, and File 3.0, where “File N.M” is shorthand for “File N, Version M”. In a capsule directory for capsule A there are original file versions for File 4.0 and File 5.0, along with modified file versions File 2.1 and File 3.1. In a capsule directory for capsule B there are modified file versions File 3.2 and File 5.1. A unified view 304 of these files, showing the most recent version of each file, includes File 1.0, File 2.1, File 3.2, File 4.0, and File 5.1.

An isolated capsule has a view of files stored within the capsule and only the most recent versions of files that does not have a version stored within the capsule. For example, the view from capsule A, where capsule A is isolated 306, includes File 1.0, File 2.1, File 3.1, File 4.0, and File 5.0.

A general capsule has a unified view across all general capsules and un-encapsulated files, encompassing the most recent version of every file not within an isolated capsule. For example, the unified view from outside of capsule A, where capsule A is isolated 308, includes File 1.0, File 2.0, File 3.2, and File 5.1. File 2.0 is included, instead of File 2.1 stored in isolated capsule A, because File 2.0 is the latest version not stored in an isolated capsule. Likewise, File 4.0, stored only in isolated capsule A, is not included because no version of the file exists outside of an isolated capsule. A general capsule, for example Capsule B, has a unified view. All general capsules have the same view.

Access by an application within a capsule to a file outside of the capsule does not alter the external file. Each capsule uses a localized copy for modified files. In some embodiments, when an application with a capsule opens a file for write access and the file is not present within the capsule, the file is copied into the capsule first and then the file-copy is opened for modification. In some cases it is more efficient to write a new file in the capsule, rather than copying a file. For example, a new file is written where an entire file would be overwritten. Registry access is handled in the same manner. All file or registry changes are maintained within the capsule. Note, however, that operating system files and memory management files (e.g., page files) reside in the operating system capsule.

For a file being opened for read-only access, the version available within the capsule view is opened. That is, while multiple versions might exist within the file system, each version associated with the same file path, the previously explained view system only reveals the most recent version; this is the version opened for reading.

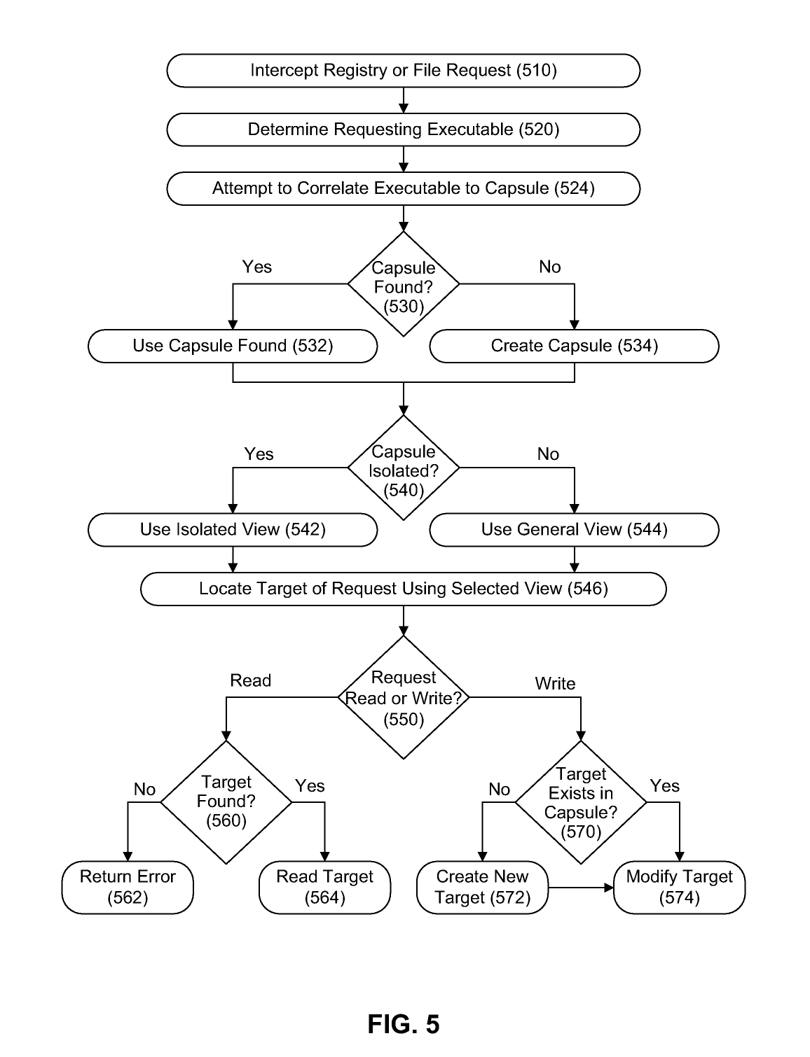

Referring to FIG. 5, the process of resolving a registry access or file system request begins by intercepting the request 510. The requesting executable is then determined 520. This can be done, for example, using the Window's PSAPI.DLL function GetProcessImageFileName( ). If the application is encapsulated, the executable path will indicate the capsule 524. If a capsule is found 530, then the determined capsule is used to resolve the request 532. If the capsule is not found, a capsule is created 534.

The requesting application's capsule determines the view used by the application executable. If the capsule is isolated 540, an isolated view is used 542. Otherwise a general unified view is used 544. The difference between views is discussed above. Using the appropriate view, the target of the request is located 546. The result of the search is processed based on the request 550. If the request is a read request, or a non-modifying request, processing depends on finding the target 560. If the target is not found, an error is returned 562. If the target is found, it is used to satisfy the request, i.e., the target is read 564.

If the request is a write request, or a modifying request, processing depends on the target's capsule status 570. If the target does not exist in the capsule, a target is created in the capsule 572. The target within the capsule is modified according to the request 574. In some cases, the target is created 572 by duplicating a target from outside of the capsule. This might be done, for example, if the request is to modify an element in a database. In other cases, it is not necessary to duplicate the target, for example if the modification is going to rewrite the target. In this scenario, creating the target means creating a new file or registry key.

When a file is deleted, if no other versions of the file exist then it is deleted. Otherwise, some special treatment is used to maintain a record of the file deletion, which is treated as a modification localized to the capsule. For example, a deleted file record is kept within the capsule. Since the record is the most recent version of the file, it will effectively be deleted from the system's name space. In some embodiments, the file's last version is not actually deleted. In a similar case, where multiple versions of a file exist and the file is renamed by a capsule, its old name version is marked as deleted and new version of the file with the new name is created. Registry modifications are handled in the same manner.

The file system view presented by the capsule manager does not include capsules which have been deactivated or deleted. Deactivating a capsule is not the same as deleting it. When a capsule is deactivated, the resident data remains but the capsule ceases to participate in the file system. When a capsule is deactivated, all processes running executable files from within the capsule are terminated and the files become invisible to file system views, just as if the capsule were isolated. However, the capsule contents remain in storage and can later be reactivated. In some implementations, capsules are activated and deactivated based on an automated trigger. For example, an administrator might configure a computer system such that certain application capsules are only available at certain times, e.g. deactivating capsules for applications that use a large amount of network bandwidth during business hours. Or, for example, only activating sensitive capsules when the system is connected to a secured corporate data network.

When a capsule is deleted, the capsule content is also deleted. Any application in the capsule is deleted along with all the application files, configuration data, and anything else contained in the capsule. In some implementations, before deleting the contents of the capsule, some files (e.g., user files) are copied to another capsule or to the native file system at the files' view-apparent locations. Merging the files in this manner reduces the data lost when deleting a capsule.

To delete a capsule without deleting the contents, i.e. to un-encapsulate an application, all of the files in the capsule are merged into another capsule or into the native file system so that only an empty capsule is deleted. Effectively, the capsule is deleted but the capsule content is moved to its native location just as if the application were installed and used on the computer without encapsulation.

Within each capsule, each file is associated with a native file system address. Separate capsules may contain files mapping to the same external address, as seen in the different file versions shown in FIG. 3 and discussed above. Similarly, in some implementations, one capsule may contain multiple file versions mapping to the same address. Triggering events render the contents of a capsule read-only such that future write attempts within the capsule are directed to a new location within the capsule. In some implementations, modifications to a read-only file are saved as file chunks with an appropriate map-file (e.g., modifications to parts of a large database file). Example triggers include: system restart; instantiation of an application; modification of a file within a capsule if the previous version of the file was created outside of the capsule; a scheduled event; installation completion; capsule import or export (disclosed in more detail below); or merger with another capsule.

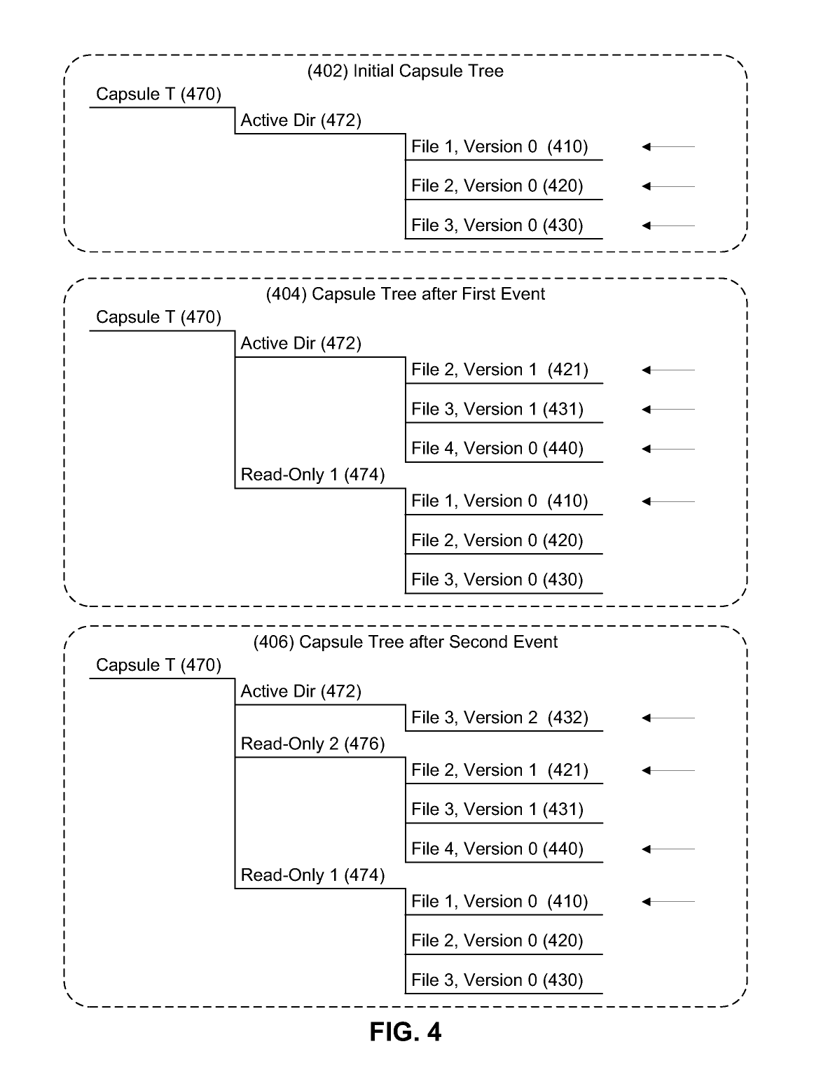

Referring to FIG. 4, in one example, multiple sub-directories within the capsule are used to separate read-only files, one directory for write-activity and the others as read-only prior versions of the capsule. An initial capsule tree 402 with root Capsule T 470 has an active directory 472 containing write-able files, for example File 1 410, File 2 420, and File 3 430. These files are the files visible to applications, as indicated by arrows. A triggering event causes the write-activity directory to become read-only and a new directory is established for future write-activity. For example, the capsule tree after a first event 404 has a read-only directory 474 containing the original versions of the files previously in the active directory 472. The active directory 472 contains any modifications of these files, for example File 2 421 and File 3 431, and any new files, for example File 4 440. A view of the capsule still shows the most recent version of each file, regardless of its sub-directory, as indicated by arrows. The process can be repeated. For example, the capsule tree after a second event 406 has the prior read-only directory 474 and a new read-only directory 476 containing the versions of the files previously in the active directory 472. The active directory 472 contains any file modifications, for example File 3 432, and any new files. A view of the capsule still shows the most recent version of each file, regardless of its sub-directory, as indicated by arrows.

A capsule can be rolled back to the time of any trigger event. In one implementation, incorporating the described sub-directory approach, read-only and active directories populated after the target trigger event are excluded from the capsule view. A system administrator can roll back and forth through a capsule's history by excluding and/or including directories. A new active directory is used for modifications going forward.

In some implementations, operating system modifications and configurations are separated from user files, for example, the operating system uses a registry. In these implementations, each capsule incorporates a registry tree for the capsule. Registry trees contain key/value pairs for use within the capsule. This data is managed in the same manner as with files, including the ability to create read-only sets of keys and the ability to rollback. In some implementations the rollback within the registry is separated from the rollback of the user files, allowing one to be done with or without the other. In some implementations application configuration is managed distinctly from application data, where configuration may include a mixture of registry entries and configuration files. In these implementations rollback of configuration can be handled separately from rollback of data.

In some implementations, each capsule contains all of the elements for associated application and makes no external modification to the operating system. An encapsulated application can be cleanly and completely removed from a system. Deleting a capsule, as described above, completely removes all of the files, and if applicable, registry entries, within the capsule. This includes all changes that an application within the capsule caused to a file system and/or registry. Likewise, restoring the capsule completely restores the application. A back-up copy of a capsule can be used to restore every element of the capsule, including settings, executable files, and data files. This can also be used to deploy copies of an application to multiple computer systems by copying the application capsule.

Different versions of an application can co-exist on a single computer system, each within its own capsule. For example, a first version of an application within an isolated capsule is invisible to a second version of the application in a separate capsule. Or in another example, a first version of an application within a deactivated capsule is invisible to a second version of the application in a separate capsule. A system administrator can test a new installation without having to remove the previous installation. User files from the multiple capsules can later be merged.

In some cases, an application installation can be moved, along with its associated configuration data and user files, from one computer to another by copying the capsule. The encapsulated application can be transferred by, and used from, network drives, USB drives, or any other portable medium. Capsules can be streamed to or from a data server connected via a data network, for example, the Internet. In some implementations, the capsule manager does not download the entire capsule. Instead, the manager downloads portions of the capsule as needed, for example, when those portions are accessed. Applications can be migrated together with application settings and user data without the need to run an application installation utility on each capsule-enabled system.

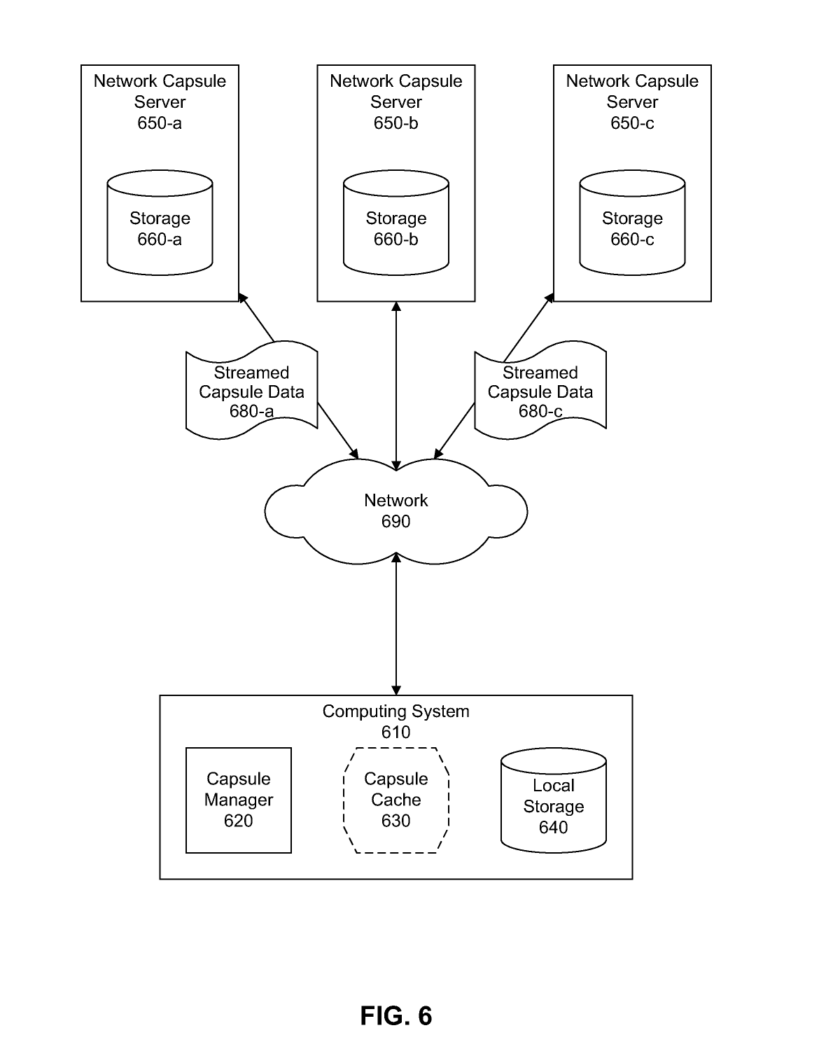

Referring to FIG. 6, an example computing system 610, with a network capsule manager 620, is connected to a data network 690 and exchanges capsule data 680 with a network capsule server 650. The capsule server 650 hosts capsule data on storage 660 accessible to the capsule server 650. A capsule manager 620 installed on computing system 610 streams capsule data 680 to and from the network capsule server 650.

Capsule data 680 contains one or more complete capsules or portions of capsules. Any kind of capsule can be streamed, including operating system capsules and user specific capsules. A user of a computer 610 with a network capsule manager 620 can stream an application from a network capsule server 650, use the application locally in the computer 610, and upload modifications to the capsule back to the network capsule server 650, for example sending back user file modifications. In some implementations, an administrator is able to modify capsules stored on network storage 660, for example, enabling an administrator to update application software or install patches.

In some implementations, the network capsule manager 620 uses a capsule cache 630 to reduce network usage. Only updates to a streamed capsule are streamed on subsequent uses. In some implementations updates or missing portions of a capsule are only streamed as needed. The capsule cache 630 and associated capsule data are stored in storage 640 local to the computing system 610. In some implementations, an application uses two capsules, one for the relatively constant application data (e.g. the executable and its associated libraries) and a second capsule for more frequently altered data (e.g. user files).

In some implementations, multiple capsule servers 650 are used, for example, one server 650-a for serving operating system capsules (which may be read-only), another server 650-b for application capsules (which may be read-only), and a third server 650-c for user capsules (which may support uploading modifications). Using multiple capsule servers a computing system 610 can exchange capsule data 680-a with a first capsule server 650-a and also exchange other capsule data 680-c with a second capsule server 650-c.

Using a networked approach to capsule distribution, multiple computers can present the same or similar computing environments to a user. For example, a computer user in an office setting using capsules can also transfer capsules to a second computer, e.g., a home computer. The capsules can be transferred by a portable medium (e.g., a portable memory card), over a network (e.g., the Internet), or in any other available manner. Entire capsules can be transferred or only portions of a capsule can be transferred.

In some embodiments, one or more capsule servers host operating system capsules, personal settings capsules, and application capsules. A user boots a local computer system which then transfers one or more operating system capsules from a capsule server. These operating system capsules are then used as the operating system for the local computer system. Personal settings and applications are also transferred from a server and used locally. In some implementations, capsules modified in the local computer system are transferred back to the host. In some implementations, alterations are synchronized to resolve alteration conflicts between multiple instances of a capsule. Synchronization can occur, for example, at the beginning or end of a user session. In some implementations, the local system is only a thin client and images (e.g., screen images) are streamed from the servers only as needed. For example, the operating system itself can be streamed from a server. In some embodiments using the streaming approach, a full operating system is also resident in the local computer to support off-line work. Synchronization of user capsules is performed once the machine is re-introduced to the network.

In some implementations, a computer system can be converted from a system with applications installed without capsules to an encapsulated system, each application in an associated capsule. In one example, when the capsule manager is installed, it can enumerate and analyze all the previously installed applications present, for example by analysis of MSI (Windows Installer, also known as Microsoft Installer or Darwin) installation records. Based on this analysis it can compose, for each application, a list of files and registry values which were created/updated during installation. Application encapsulation can be performed according to this list. However, MSI records are not always complete; for example, files/registry values updated at application run-time (as opposed to install-time) will not be included. In some embodiments, conversion to an encapsulated system does not move pre-existing files or registry entries. Rather, the pre-existing application files and registry entries are associated with new capsules and the capsules only contain files and registry entries created or modified after the encapsulation.

In another example, the capsule manager can simulate the process of application un-installation without actually changing the native file system or registry. For example, a module capable of capturing file and registry requests (e.g. part of the capsule manager) captures the un-installers requests and simulates the correct responses for un-installation. A list of files/registry values requested during this process serves as a basis for application encapsulation. The process is untraceable by the user as installation dialogs are kept invisible and installer logs are cleaned up. The resulting capsule includes all files and registry settings that would have been removed by the uninstaller.

In another example, where pre-installed applications are well known, the capsule manager uses a knowledge base to determine the files and registry settings to be included in a capsule. This approach takes into consideration the environment of the computer system, for example operating system, service pack or patch level, and dependencies on other applications. The knowledge base can include configuration units known to be updated at application run-time.

In another example, where the Operating System is encapsulated, there are three spaces each populated with one or more capsules: An Operating System space; an application space; and a user space. A computing environment is created by selecting one or more capsules from each space. In some implementations, the operating system capsule and/or application capsules are streamed from one computer to another. The streamed capsules are treated as read-only, restricting user modifications to user capsules. In some cases, user capsules are also streamed from one computer to another, for example, storing user capsules on a data server accessible from other computer systems. Maintenance and modification of the Operating System capsules and/or application capsules is performed on the stream source, simplifying patching or upgrading. The implementation of such a system can be done in a variety of ways, including implementation based on VMware, based on the driver which will deliver to the desktops separate images of the Operating System.

In another example, a system may be configured with multiple modes. For example, a laptop computer is set up with two modes, one for use “at work” and another for use “at home.” The “at work” mode deactivates the capsules supporting non-business applications (e.g., games) and activates work applications (e.g., software for accessing the corporate network). The “at home” mode reverses the activations, enabling the non-business applications and disabling work-specific applications (e.g., preventing unauthorized access to the corporate network). In some examples, the modes may be activated/deactivated remotely by an administrator. In other examples, one or more capsules may be individually enabled or disabled through a remote action taken by an administrator.

For example, the system may be portable (e.g., a laptop or notebook computer) and configured with a listing of authorized business capsules. When the portable system is connected to a corporate network (e.g., when it is logged into a virtual private network, VPN), only the authorized business capsules are activated. When the portable system is not connected to the corporate network, the user can activate other capsules that may have been deactivated while the portable system was on the corporate network. In this way, a person using a corporate laptop might install an application while disconnected (e.g., while at home or at a conference), but the system operates as though the unauthorized application was never installed while the system is connected to the corporate network. Unauthorized applications can also easily be removed by deleting the unauthorized application capsule.

In another example, a computer system may be configured to prevent the user from modifying the environment settings, for example, by placing the operating system and/or its configuration in one or more read-only capsules. An application expecting administrative rights to a computer, including the ability to alter the operating system or its configuration, is placed in a capsule with a localized view of the operating system. Modifications made within the capsule are not reflected outside of the capsule, and can be undone by reverting to an earlier snapshot, e.g., an initial preferred state snapshot or a “golden state.” In some implementations, the application has administrative permissions, but the application's ability to modify the system is constrained. In some implementations, the capsule always reverts to the golden state at the beginning or ending of each usage.

The capsule manager may be implemented to be crash resistant. For example, the capsule manager may maintain a journal of capsule activity through the use of file system checkpoints. After a failure, the system can be rolled back to a previous checkpoint (e.g., the most recent checkpoint), placing the system in a known stable state, or in-progress transactions can be completed. In implementations where the capsule manager communicates with a networked capsule host, the journaling can also include network activity. This ensures that only completed capsule changes impact the system and simplifies crash recovery.

At times in this description, applications are described as making requests that are intercepted by the capsule manager 130. It should be understood that in some instances, a request intercepted by the capsule manager is generated by a process of an executable whose executable file is associated with encapsulated application. The capsule manager 130 may be implemented to resolve process identification number (PID) of a requesting process to a capsule identifier based on a series of mappings (e.g., PID to executable, executable to application, and application to capsule).

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A method for processing element access requests in a computing environment having a plurality of applications, the method comprising:
managing versions of elements of a first set of applications as belonging to respective application execution groups of a first group type, each application execution group of the first group type having a unique group identifier;
identifying a source of a first element access request as being associated with the first set of applications, the first element access request including a first element identifier;
based on the identified source of the first element access request, selecting a version of an element stored in association with the first element identifier from amongst the managed versions of the elements of the first set of applications; and
processing the first element access request using data representative of the selected version of the element.

2. The method of claim 1, wherein the elements of the first set of applications comprise executable files, dynamic link libraries, configuration files, registry entries, and user generated files.

3. The method of claim 1, wherein the first set of applications comprises a subset of the plurality of applications of the computing environment.

4. The method of claim 3, wherein the first set of applications comprises a proper subset of the plurality of applications of the computing environment.

5. The method of claim 1, wherein the selected version of the element is further stored in association with a group identifier.

6. The method of claim 5, wherein the first group type comprises a non-isolated group type and the selected version of the element is further stored in association with a group identifier of an application execution group of the first group type.

7. The method of claim 1, wherein the version of the element selected based on the identified source of the first element access request is a most recent version of the element with respect to the application execution groups of the first group type.

8. The method of claim 1, further comprising:
managing versions of elements of a second set of applications as belonging to respective application execution groups of a second group type;
identifying a source of a second element access request as being associated with the second set of applications, the second element access request including the first element identifier;
based on the identified source of the second element access request, selecting a version of an element stored in association with the first element identifier from amongst the managed versions of the elements of the second set of applications; and
processing the second element access request using data representative of the version of the element selected based on the identified source of the second element access request.

9. The method of claim 8, wherein the version of the element selected based on the identified source of the first element access request is different from the version of the element selected based on the identified source of the second element access request.

10. The method of claim 8, wherein the version of the element selected based on the identified source of the second element access request is a most recent version of the element with respect to the application execution groups of the second group type.

11. The method of claim 8, wherein the second group type comprises an isolated group type, and the version of the element selected based on the identified source of the second element access request is further stored in association with a group identifier of an application execution group of the second group type.

12. The method of claim 1, wherein the first element access request is for access to a file.

13. The method of claim 1, wherein the first element access request is for access to an entry in a registry.

14. A method for processing read/write requests in a computing environment having a plurality of applications, the method comprising:
managing versions of elements of a first set of applications as belonging to respective application execution groups of a first group type, each application execution group of the first group type having a unique group identifier;
receiving a write request that includes a first element identifier and an element content;
identifying a source of the write request as being associated with a first application execution group of the first group type; and
executing a write operation that includes storing the element content in association with both the first element identifier and a group identifier of the first application execution group.

15. The method of claim 14, wherein the elements of the first set of applications comprise executable files, dynamic link libraries, configuration files, registry entries, and user generated files.

16. The method of claim 14, wherein the first group type comprises an isolated group type, the method further comprising:
receiving a read request that includes the first element identifier;
identifying a source of the read request as being associated with the first application execution group of the isolated group type;
identifying a most recent version of an element stored in association with both the first element identifier and the group identifier of the first application execution group; and
processing the read request using data representative of the identified most recent version of the element.

17. The method of claim 14, wherein the first group type comprises an isolated group type, the method further comprising:
receiving a read request that includes the first element identifier;
identifying a source of the read request as being associated with a second application execution group of the isolated group type;
identifying a most recent version of an element that is either: (a) stored in association with the first element identifier and a group identifier of an application execution group of a non-isolated group type, or (b) stored in association with the first element identifier and not stored in association with a group identifier; and
processing the read request using data representative of the identified most recent version of the element.

18. The method of claim 14, wherein the first group type comprises a non-isolated group type, the method further comprising:
receiving a read request that includes the first element identifier;
identifying a source of the read request as being associated with a second application execution group of the non-isolated group type;
identifying a most recent version of an element that is either: (a) stored in association with the first element identifier and a group identifier of an application execution group of a non-isolated group type, or (b) stored in association with the first element identifier and not stored in association with a group identifier; and
processing the read request using data representative of the identified most recent version of the element.

19. The method of claim 14, wherein the element content comprises registry content.

20. The method of claim 14, wherein the element content comprises file system content.

21. A method comprising:
managing versions of elements of a first set of applications of a computing environment as belonging to respective application execution groups;
maintaining a first group-specific temporal snapshot sequence for a first application execution group, each snapshot of the first group-specific temporal snapshot sequence including data representative of a state of each element of the first application execution group at a point in time corresponding to a detection of a snapshot trigger event, wherein the state of each element is based in part on the effects of one or more write operations initiated by respective sources associated with the first application execution group between snapshot trigger events corresponding to adjacent points in time; and
processing the first group-specific temporal snapshot sequence to restore one or more of the elements of the first application execution group to its respective state at a point in time corresponding to a specific snapshot trigger event.

22. The method of claim 21, further comprising:
maintaining a second group-specific temporal snapshot sequence for a second application execution group, each snapshot of the second group-specific temporal snapshot sequence including data representative of a state of each element of the second application execution group at a point in time corresponding to a detection of a snapshot trigger event, wherein the state of each element is based in part on the effects of one or more write operations initiated by respective sources associated with the second application execution group between snapshot trigger events corresponding to adjacent points in time; and
processing the second group-specific temporal snapshot sequence to restore one or more of the elements of the second application execution group to its respective state at a point in time corresponding to the specific snapshot trigger event.

23. The method of claim 21, wherein the elements of the first set of applications comprise executable files, dynamic link libraries, configuration files, registry entries, and user generated files.

24. The method of claim 21, wherein the first set of applications comprises a subset of the plurality of applications of the computing environment.

25. The method of claim 24, wherein the first set of applications comprises a proper subset of the plurality of applications of the computing environment.

26. A method comprising:
managing versions of elements of a first set of applications of a computing environment as belonging to respective capsules;
maintaining one or more capsule-specific temporal snapshot sequences for each application of the first set, each capsule-specific temporal snapshot sequence comprising information sufficient to enable elements of an application to reflect its respective state at a point in time corresponding to a specific snapshot trigger event; and
processing a capsule-specific temporal sequence for a first application of the first set and a capsule-specific temporal sequence for a second application of the first set to concurrently enable elements of the first application to reflect its respective state at a first point in time and elements of the second application to reflect its respective state at a second point in time.

27. The method of claim 26, wherein the second point in time is subsequent to the first point in time.

28. The method of claim 26, further comprising:
concurrently enabling elements of the first application to reflect its respective state at a point in time corresponding to a first snapshot trigger event and elements of the second application to reflect its respect state at the point in time corresponding to the first snapshot trigger event.

29. The method of claim 26, wherein maintaining one or more capsule-specific temporal snapshot sequences for each application of the first set comprises:
maintaining a first capsule-specific temporal snapshot sequence for a first version of the first application and maintaining a second capsule-specific temporal snapshot sequence for a second version of the first application.

30. The method of claim 26, wherein the elements of the first set of applications comprise executable files, dynamic link libraries, configuration files, registry entries, and user generated files.

31. The method of claim 26, wherein the first set of applications comprises a subset of the plurality of applications of the computing environment.

32. The method of claim 31, wherein the first set of applications comprises a proper subset of the plurality of applications of the computing environment.

33. A distributed system hosted on a plurality of interconnected nodes of a data network, the system comprising:
a first node of the data network, the first node including a processor and a machine-readable medium that stores instructions executable by the processor to:
manage versions of elements of a first set of applications hosted on the first node as belonging to respective application execution groups of a first group type, each application execution group of the first group type having a unique group identifier;
identify a source of a first element access request as being associated with the first set of applications, the first element access request including a first element identifier;
based on the identified source of the first element access request, select a version of an element stored in association with the first element identifier from amongst the managed versions of the elements of the first set of applications; and
process the first element access request using data representative of the selected version of the element.

34. The system of claim 33, wherein the elements of the first set of applications comprise executable files, dynamic link libraries, configuration files, registry entries, and user generated files.

35. The system of claim 33, wherein the selected version of the element is further stored in association with a group identifier.

36. The system of claim 35, wherein the first group type comprises a non-isolated group type and the selected version of the element is further stored in association with a group identifier of an application execution group of the first group type.

37. The system of claim 33, wherein the version of the element selected based on the identified source of the first element access request is a most recent version of the element with respect to the application execution groups of the first group type.

38. The system of claim 33, wherein machine-readable medium of the first node further stores instructions executable by the processor to:
manage versions of elements of a second set of applications as belonging to respective application execution groups of a second group type;
identify a source of a second element access request as being associated with the second set of applications, the second element access request including the first element identifier;
based on the identified source of the second element access request, select a version of an element stored in association with the first element identifier from amongst the managed versions of the elements of the second set of applications; and
process the second element access request using data representative of the version of the element selected based on the identified source of the second element access request.

39. The system of claim 38, wherein the version of the element selected based on the identified source of the first element access request is different from the version of the element selected based on the identified source of the second element access request.

40. The system of claim 38, wherein the version of the element selected based on the identified source of the second element access request is a most recent version of the element with respect to the application execution groups of the second group type.

41. The system of claim 38, wherein the second group type comprises an isolated group type, and the version of the element selected based on the identified source of the second element access request is further stored in association with a group identifier of an application execution group of the second group type.

42. The system of claim 33, wherein the machine-readable medium of the first node further stores instructions executable by the processor to:
receive elements of a first application from a second node of the data network; and
manage the received elements of the first application as belonging to a first application execution group of the first group type.

43. The system of claim 33, further comprising:
a second node of the data network, the second node including a processor and a machine-readable medium that stores elements of a second set of applications and instructions executable by the processor to:
process a request for elements of an application of the second set; and
send elements of the application of the second set to a source of the request.

44. The system of claim 43, wherein the source of the request comprises the first node of the data network.

45. The system of claim 43, wherein the source of the request comprises a third node of the data network.

46. The system of claim 43, wherein the first node of the data network comprises a client computing system and the second node of the data network comprises a server computing system.

47. A distributed system hosted on a plurality of interconnected nodes of a data network, the system comprising:
a first node of the data network, the first node including:
a processor;
a first machine-readable medium that stores a set of data collections, each data collection being comprised of one or more elements of a particular content type; and
a second machine-readable medium that stores instructions executable by the processor to:
receive a request specifying a first data collection of the set; and
send one or more elements of the first data collection of the set to a source of the request.

48. The system of claim 47, further comprising:
a second node of the data network, the second node including:
a processor; and
a machine-readable medium that stores instructions executable by the processor to:
receive one or more elements of a first content type from the first node; and
manage the received one or more elements as belonging to a first data collection of the first content type.

49. The system of claim 48, wherein the first node of the data network comprises a server computing system and the second node of the data network comprises a client computing system.

50. The system of claim 48, wherein the machine-readable medium of the second node further stores instructions executable by the processor to:
generate a request of one or more other elements of the first content type; and
send the generated request to the first node.

51. The system of claim 50, wherein the machine-readable medium of the second node further stores instructions executable by the processor to:
receive the one or more other elements of the first content type from the first node; and
manage the received one or more elements and the received one or more other elements as belonging to the first data collection of the first content type.

52. The system of claim 48, wherein the machine-readable medium of the second node further stores instructions executable by the processor to:
generate a request of one or more other elements of the first content type; and
send the generated request to a third node.

53. The system of claim 52, wherein the machine-readable medium of the second node further stores instructions executable by the processor to:
receive the one or more other elements of the first content type from the third node; and
manage the one or more elements received from the first node and the one or more other elements received from the second node as belonging to the first data collection of the first content type.

54. The system of claim 48, wherein the machine-readable medium of the second node further stores instructions executable by the processor to manage the received one or more elements as belonging to a read-only first data collection of the first content type.

55. The system of claim 47, wherein the data collections of the set include one or more of the following: an operating system data collection, an application program data collection, a user data collection, and a configuration data collection.

56. The system of claim 47, wherein the source of the request comprises the second node of the data network.

57. The system of claim 47, wherein the source of the request comprises a third node of the data network.
